(19) United States
(12) Patent Application Publication
(10) Pub. No.: US 2016/0067640 A1
(43) Pub. Date: Mar. 10, 2016

(54) Precision pool cleaners

(71) Applicant: Clint Jackson, San Angelo, TX (US)

(72) Inventor: Clint Jackson, San Angelo, TX (US)

(21) Appl. No.: 14/121,086

(22) Filed: Sep. 8, 2014

(51) Int. Cl. B01D 35/26; E04H 4/16; C02F 1/00; B01D 35/00

(52) U.S. Cl. CPC B01D 35/26; B01D 35/005; E04H 4/16; C02F 1/001; B01D 2201/40; C02F 2103/42

(57) ABSTRACT

A precision pool cleaner, it may include a swimming pool filter made to clean pool water including of one submersible pump with flexible tubing, a reducing coupling and a container filled with polyfiber with holes drilled in the bottom; then placing it in the water plugging in into an outlet causing the water to be filtered thru the pump and pushed thru the drum out the bottom causing the water to be clean and blue.

### BACKGROUND OF THE INVENTION

The present invention relates to a process for cleaning pool water.

### BRIEF DESCRIPTION OF THE DRAWING

FIG. 1 illustrates the present invention.

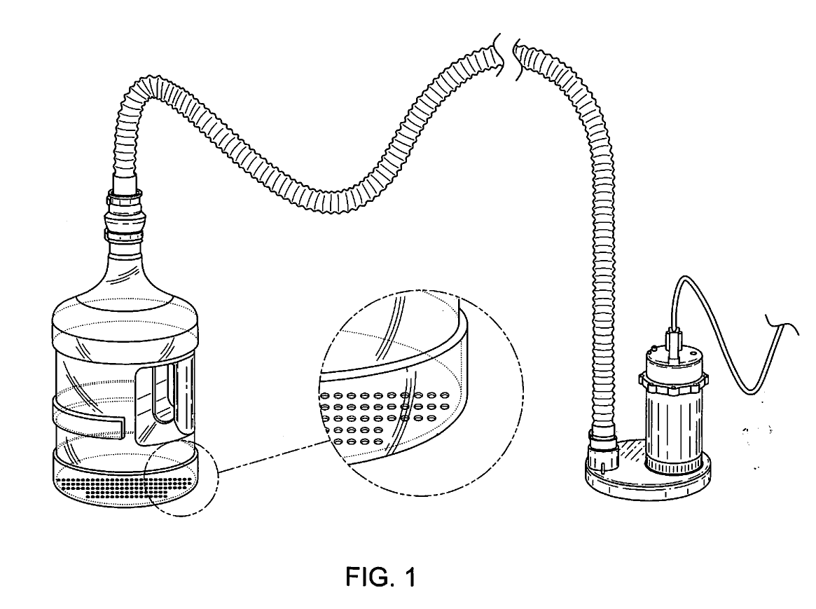

### DESCRIPTION

The present invention includes (a) ⅓ horsepower water submersible pump; (b) 6 ft. of 1″ & ¾″ flexible poly tubing; (c) One reducing coupling 2″ to 1 ½″ made of rubber; and (d) One 5 gal. drum filled with polyfiber with holes in the bottom of the drum.

A precision pool cleaner, comprising:

a swimming pool filter made to clean pool water consisting of one submersible pump with flexible tubing, a reducing coupling and a container filled with polyfiber with holes drilled in the bottom;

then placing it in the water plugging in into an outlet causing the water to be filtered thru the pump and pushed thru the drum out the bottom causing the water to be clean and blue.

1. A pool cleaner for cleaning a pool, comprising:
a water submersible pump for pushing water through the pool cleaner;
a flexible tube for transferring water from pump to a filter a reducing coupling for connecting the tube to the filter a drum to allow dirty water to flows in and clean water flows out.

2. A pool cleaner as in claim 1, wherein the pump is ⅓ hp.

3. A pool cleaner as in claim 1, wherein the tube is a polytube.

4. A pool cleaner as in claim 1, wherein the coupling is 2 inches.
